(19) United States
(12) Patent Application Publication
(10) Pub. No.: US 2009/0067435 A1
(43) Pub. Date: Mar. 12, 2009

(54) SYSTEMS, METHODS AND COMPUTER PRODUCTS FOR A TCP/IP STACK TO NOTIFY AN APPLICATION OF A STATE CHANGE MADE TO ALL ROUTES OVER A SINGLE IPV4 INTERFACE

(75) Inventors: Alan G. Packett, Raleigh, NC (US); Ahilan Rajadeva, Newburgh, NY (US); David P. Zingaretti, Port Ewen, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/853,372

(22) Filed: Sep. 11, 2007

(51) Int. Cl. H04L 12/56

(52) U.S. Cl. 370/395.31

(57) ABSTRACT

Systems, methods and computer products for a TCP/IP stack to notify an application of a state change made to all routes over a single IPV4 interface. Exemplary embodiments include a including creating a master socket to the TCP/IP stack, obtaining all IPV4 active and inactive home interfaces from the TCP/IP stack, building and maintaining a home interface hash table of the obtained home interfaces, obtaining all the IPV4 host and network routes from the TCP/IP stack, building and maintaining a route hash table of obtained host and network routes, determining that a route is active when the route's home interface is active, receiving a notification via the master socket from the TCP/IP stack in response to a state change occurring in a home interface, and changing a respective state entry of the home interface in the home interface hash table.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to TCP/IP stacks, and particularly to systems, methods and computer products for a TCP/IP stack to notify an application of a state change made to all routes over a single IPV4 interface.

2. Description of Background

TCP/IP (i.e., Internet Protocol Version 4 (IPV4)) networks are growing, resulting in route tables that can sometimes contain thousands of routes. In addition, the routes in the route table that use any single TCP/IP stack interface can also be very large in number. When an application has obtained the route table contents from the TCP/IP stack, it is likely that the application needs to maintain those route table contents by learning of subsequent changes made to the route table by the TCP/IP stack. One such change is the activation or deactivation of all routes that use a particular TCP/IP stack interface, due to the activation or deactivation of the interface itself. The application must then currently learn of these route changes using several methods. For example, the application can re-obtain the contents of the route table from the TCP/IP stack. This method has the disadvantage that both the application and the TCP/IP stack must process the entire route table, even when only a small percentage of the routes have changed. In another example, the TCP/IP stack can notify the application of each of the routes in the route table that was updated due to the activation or deactivation of the interface. This method has the disadvantage that a large number of routes must be communicated when there are many routes in the route table that use that interface.

### SUMMARY OF THE INVENTION

Exemplary embodiments include a method in a TCP/IP stack having a plurality of IPV4 interfaces, to notify an application of a state change made to all routes over a single IPV4 interface, the method including creating a master socket to the TCP/IP stack, obtaining all IPV4 active and inactive home interfaces from the TCP/IP stack, building and maintaining a home interface hash table of the obtained home interfaces, wherein an associated active and inactive state is maintained in a respective home interface entry of the home interface hash table, obtaining all the IPV4 host and network routes from the TCP/IP stack, wherein each respective route entry includes the respective route's home interface, building and maintaining a route hash table of obtained host and network routes, determining that a route is active when the route's home interface is active, receiving a notification via the master socket from the TCP/IP stack in response to a state change occurring in a home interface, wherein the notification identifies the home interface and the state change of the home interface and changing a respective state entry of the home interface in the home interface hash table.

Further exemplary embodiments include an article of manufacture, including a set of program interfaces embodies on a computer readable medium for execution on a computer in conjunction with an application program that notifies an application of a state change made to all routes over a single IPV4 interface in a TCP/IP stack, the set of program interfaces for creating a master socket to the TCP/IP stack, obtaining all IPV4 active and inactive home interfaces from the TCP/IP stack, building and maintaining a home interface hash table of the obtained home interfaces, wherein an associated active and inactive state is maintained in a respective home interface entry of the home interface hash table, obtaining all the IPV4 host and network routes from the TCP/IP stack, wherein each respective route entry includes the respective route's home interface, building and maintaining a route hash table of obtained host and network routes, determining that a route is active when the route's home interface is active, including locating the respective route in the route hash table prior to sending a routing request to the TCP/IP stack, wherein the route entry in the route hash table identifies the route's home interface, locating the route's home interface in the home interface hash table, sending a request to the TCP/IP stack in response to the home interface being active, thus indicating that the route is active, receiving a notification via the master socket from the TCP/IP stack in response to a state change occurring in a home interface, wherein the notification identifies the home interface and the state change of the home interface and changing a respective state entry of the home interface in the home interface hash table.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution in which a TCP/IP stack notifies an application of a state change made to all routes over a single IPV4 interface.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a TCP/IP stack in accordance with exemplary embodiments; and

FIG. 2 illustrates an exemplary TCP/IP stack notification method in which the TCP/IP stack notifies an application of a state change made to all routes over a single IPV4 interface in accordance with exemplary embodiments.

The detailed description explains the preferred embodiments of the invention, together with advantages and features, by way of example with reference to the drawings.

### DETAILED DESCRIPTION OF THE INVENTION

In exemplary embodiments, the systems and methods described herein route IPV4 traffic to the correct instance of TCP/IP on a processing system having multiple instances of TCP/IP. The correct instance of TCP/IP may be selected by establishing a master routing table, which contains the network interface and route information for each instance of TCP/IP in the configuration. In exemplary embodiments, a new notification type to be sent by the TCP/IP stack to the application when an interface is activated or deactivated. The notification contains the identification of the interface as well as the new interface state (active or inactive). On receipt of this notification, the application can make the appropriate modification to the routes in the route table that use that interface. Performance improvements are realized. The activation or deactivation of a TCP/IP stack interface may result in the modification of a small percentage of the routes in the route table or it may result in the modification of a large number of routes in the route table. In both cases, the application is notified of the change with a single, small notification sent by the TCP/IP stack to the application. The processing required in both the stack and the application involves only the interface in question and the associated routes.

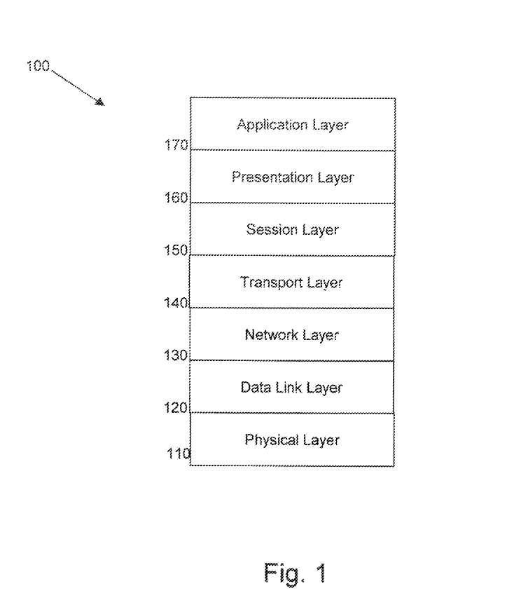

Turning now to the drawings in greater detail, it will be seen that in FIG. 1 there is a TCP/IP stack 100 in accordance with exemplary embodiments. In exemplary embodiments the TCP/IP stack 100 includes a physical layer 110 through which data is physically moved across a network interface. All of the other layers perform useful functions to create messages to be sent, but they must all be transmitted down the protocol stack. Details of operation of cables, connectors, radio transceivers, network interface cards and other hardware devices are generally a function of the physical layer 110. Functions of the physical layer 110 include encoding and signaling, data transmission and reception, and topology and physical network design. In exemplary embodiments, the TCP/IP stack 100 further includes a data link layer 120 that includes functions including media access control, data framing, addressing, and error detection and handling. In exemplary embodiments, the TCP/IP stack 100 further includes a network layer 130 that defines inter-network connectivity. The network layer 130 functionality includes logical addressing, data routing, datagram encapsulation, fragmentation and reassembly, and error handling and diagnostics. In exemplary embodiments, the TCP/IP stack further includes a transport layer 140 that includes functions such as high-level transport of data, providing the necessary functions to enable communication between software application processes on different computers, and end-to-end or host-to-host transport. In exemplary embodiments, the TCP/IP stack 100 further includes a session layer 150 that includes functions such as handling software application issues, allowing devices to establish and manage sessions, providing the means necessary to set up, manage, and end sessions. Session-layer tools are provided to higher layer protocols through command sets often called application program interfaces or APIs, which include NetBIOS, TCP/IP sockets and remote procedure calls (RPCs), which allow an application to accomplish certain high-level communications over the network, by using a standardized set of services. In exemplary embodiments, the TCP/IP stack further includes a presentation layer 160 that includes functions such as handling the presentation of data including translation compression, and encryption. In exemplary embodiments, the TCP/IP stack 100 further includes an application layer 170 used by network applications to implement the functions performed by users to accomplish various tasks over the network. There are many application layer protocols that enable various functions at this layer including HTTP, FTP, SMTP, DHCP, NFS, Telnet, SNMP, POP3, NNTP and IRC.

As described herein, a new notification type to be sent by the TCP/IP stack 100 to the application via the application layer 170 when an interface is activated or deactivated. The notification contains the identification of the interface as well as the new interface state (active or inactive). On receipt of this notification, the application can make the appropriate modification to the routes in the route table that use that interface. Performance improvements are realized.

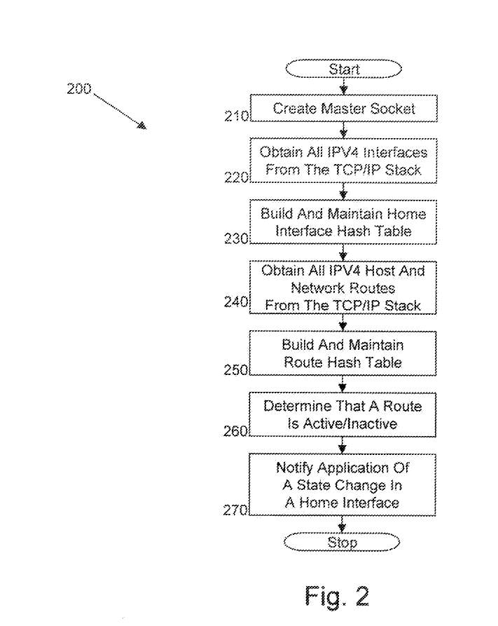

FIG. 2 illustrates an exemplary TCP/IP stack notification method 200 in which the TCP/IP stack notifies an application of a state change made to all routes over a single IPV4 interface in accordance with exemplary embodiments. At step 210, an application creates a permanent AF_INET stream socket connection (i.e., mater socket) to the TCP/IP stack. At step 220, using the master socket, the application obtains all the IPV4 home interfaces from the TCP/IP stack 100. In exemplary embodiments, both active and inactive interfaces are returned. At step 230, the application builds and maintains a hash table (home interface hash table) of the obtained home interfaces. In exemplary embodiments, the state (active/inactive) is maintained in each home interface entry. At step 240, using the master socket, the application obtains all the IPV4 host and network routes from the TCP/IP stack 100. In exemplary embodiments, each returned route entry identifies the route's home interface. At step 250, the application builds and maintains a hash table (route hash table) of obtained host and network routes. At step 260, the application can determine that a route is active when its home interface is active. In exemplary embodiments, prior to sending a routing request to the stack, the application finds the route in its route hash table. The route entry in the route hash table identifies the route's home interface. Furthermore, the application finds the route's home interface in its home interface hash table. In exemplary embodiments, if the home interface is active, the route is active and the request is sent to the TCP/IP stack 100. At step 270, when a state change occurs in a home interface, the TCP/IP stack 100, using the master socket, notifies the application. In exemplary embodiments, the notification identifies the home interface and the state change (active/inactive) and the application changes the state of the home interface in its home interface hash table.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. In a TCP/IP stack having a plurality of IPV4 interfaces, a method to notify an application of a state change made to all routes over a single IPV4 interface, the method comprising:
creating a master socket to the TCP/IP stack;
obtaining all IPV4 active and inactive home interfaces from the TCP/IP stack;
building and maintaining a home interface hash table of the obtained home interfaces, wherein an associated active and inactive state is maintained in a respective home interface entry of the home interface hash table;
obtaining all the IPV4 host and network routes from the TCP/IP stack, wherein each respective route entry includes the respective route's home interface;
building and maintaining a route hash table of obtained host and network routes;
determining that a route is active when the route's home interface is active;
receiving a notification via the master socket from the TCP/IP stack in response to a state change occurring in a home interface, wherein the notification identifies the home interface and the state change of the home interface; and
changing a respective state entry of the home interface in the home interface hash table.

2. The method as claimed in claim 1 wherein the master socket is a permanent AF_INET stream socket connection.

3. The method as claimed in claim 2 wherein determining that a route is active when the route's home interface is active comprises:
locating the respective route in the route hash table prior to sending a routing request to the TCP/IP stack, wherein the route entry in the route hash table identities the route's home interface.
locating the route's home interface in the home interface hash table; and
sending a request to the TCP/IP stack in response to the home interface being active, thus indicating that the route is active.

4. An article of manufacture, comprising:
a set of program interfaces embodies on a computer readable medium for execution on a computer in conjunction with an application program that notifies an application of a state change made to all routes over a single IPV4 interface in a TCP/IP stack, the set of program interfaces for:
creating a master socket to the TCP/IP stack;
obtaining all IPV4 active and inactive home interfaces from the TCP/IP stack;
building and maintaining a home interface hash table of the obtained home interfaces, wherein an associated active and inactive state is maintained in a respective home interface entry of the home interface hash table;
obtaining all the IPV4 host and network routes from the TCP/IP stack, wherein each respective route entry includes the respective route's home interface;
building and maintaining a route hash table of obtained host and network routes;
determining that a route is active when the route's home interface is active, including:
locating the respective route in the route hash table prior to sending a routing request to the TCP/IP stack, wherein the route entry in the route hash table identifies the route's home interface;
locating the route's home interface in the home interface hash table;
sending a request to the TCP/IP stack in response to the home interface being active, thus indicating that the route is active;
receiving a notification via the master socket from the TCP/IP stack in response to a state change occurring in a home interface, wherein the notification identifies the home interface and the state change of the home interface; and
changing a respective state entry of the home interface in the home interface hash table.

5. The article of manufacture as claimed in claim 4 wherein the master socket is a permanent AP_INET stream socket connection.
